(19) United States
(12) Patent Application Publication
(10) Pub. No.: US 2009/0198079 A1
(43) Pub. Date: Aug. 6, 2009

(54) PROCESS FOR PREPARING METAL ORGANIC FRAMEWORKS COMPRISING METALS OF TRANSITION GROUP IV

(75) Inventors: Markus Schubert, Ludwigshafen (DE); Ulrich Muller, Neustadt (DE); Stefan Marx, Berlin (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE

(21) Appl. No.: 12/297,289

(22) PCT Filed: Apr. 18, 2007
(86) PCT No.: PCT/EP2007/053781

§ 371 Date: Jan. 23, 2009

(30) Foreign Application Priority Data
Apr. 18, 2006 (DE) 06112715.5

(51) Int. Cl. C07F 7/00

(52) U.S. Cl. 556/55

(57) ABSTRACT

The present invention relates to a process for preparing a porous metal organic framework comprising at least one at least bidentate organic compound coordinated to at least one metal ion, which comprises the step
reaction of at least one metal compound with at least one at least bidentate organic compound which can coordinate to the metal, with the metal ion of the at least one metal compound being selected from the group of metals consisting of titanium, zirconium and hafnium and the at least one at least bidentate organic compound being derived from a dicarboxylic, tricarboxylic or tetracarboxylic acid,
   wherein the metal compound is an inorganic salt.

The present invention relates to a process for preparing porous metal organic frameworks.

Porous metal organic frameworks are known in the prior art and form an interesting class of substances which can be an alternative to organic zeolites for various applications.

Metal organic frameworks usually comprise an at least bidentate organic compound coordinated to a metal ion. The framework is typically present as a continuous framework. A specific group of these metal organic frameworks has recently been described as “limited” frameworks in which, as a result of specific selection of the organic compound, the framework does not extend without limit but forms polyhedra (A. C. Sudik et al., J. Am. Chem. Soc. 127 (2005), 7110-7118). However, this latter specific group, too, is ultimately a porous metal organic framework.

Particular applications for which the metal organic frameworks have been used are, for example, in the field of storage, separation or controlled release of chemical substances, for example gases, or in the field of catalysis. Here, both the porosity of the organic material and the choice of the appropriate metal ion play an important role.

Processes for specific porous metal organic frameworks based on titanium or zirconium are proposed in the literature for particular applications.

Thus, for example, T. Sawaki et al., J. Am. Chem. Soc. 120 (1998), 8539-8540, describe the preparation of a microporous solid Lewis acid catalyst by reaction of the suspension of an anthracenebisresorcinol derivative and titanium diisopropoxide dichloride at room temperature.

H. L. Ngo et al., J. Mol. Catal. A. Chemical 215 (2004), 177-186, describe titanium and zirconium metal organic frameworks in which a bisnaphthyldiphosphonate is used as bidendate organic compound and the hydroxylate groups can also be bound to titanium without the titanium participating in formation of the framework. Here, the organic compound is reacted with zirconium tetra-n-butoxide to produce the metal organic framework.

A. Hu et al., J. Am. Chem. Soc. 125 (2003), 11490-11491, likewise describe such zirconium-based metal organic frameworks for the heterogeneous asymmetric hydrogenation of aromatic ketones, but in this case ruthenium is used instead of titanium the hydroxy groups are replaced by phosphine. Here too, a zirconium butoxide is used as metal compound for preparing the metal organic frameworks.

The preparation of such a system is likewise described by A. Hu et al., Angew. Chem. Int. Ed. 42 (2003), 6000-6003.

The preparation of titanium-bridged bisnaphthols as framework is described by S. Takizawa et al., Angew. Chem. Int. Ed. 42 (2003), 5711-5714. Here too, the metal is provided as an alkoxide, namely titanium tetraisopropoxide, for preparing the framework.

In addition, J. M. Tanski et al., Inorg. Chem. 40 (2001), 2026-2033, describe a titanium-based dihydroxynaphthalene framework as Ziegler-Natta catalyst, with titanium tetraisopropoxide likewise being used as metal starting material.

All the abovementioned documents start from metal compounds which are at least partially organic in nature for preparing titanium- and/or zirconium-based metal organic frameworks. Propoxides or butoxides are typically used.

A disadvantage of such starting compounds is the presence of a further organic compound in the form of the organic anion of the metal compound in the reaction. This frequently leads to the problem that this organic anion has to be removed, sometimes with great difficulty, from the metal organic framework.

It is therefore an object of the present invention to provide a process for preparing titanium- and/or zirconium-based porous metal organic frameworks which avoids the above-described problem.

The object is achieved by a process for preparing a porous metal organic framework comprising at least one at least bidentate organic compound coordinated to at least one metal ion, which comprises the step
reaction of at least one metal compound with at least one at least bidentate organic compound which can coordinate to the metal, with the metal ion of the at least one metal compound being selected from the group of metals consisting of titanium, zirconium and hafnium and the at least one at least bidentate organic compound being derived from a dicarboxylic, tricarboxylic or tetracarboxylic acid,
wherein the metal compound is an inorganic salt.

It has been found that the abovementioned disadvantages can be avoided by use of a purely inorganic salt, so that, in particular, metal organic frameworks comprising metals of transition group IV can be prepared simply in large amounts.

The porous metal organic framework prepared by the process of the invention comprises at least one metal ion. This metal ion is an ion of a metal selected from the group consisting of titanium, zirconium and hafnium. The metal is preferably zirconium.

However, it is likewise possible for more than one metal ion to be present in the porous metal organic framework. This metal ion can be located in the pores of the metal organic framework or participate in formation of the framework lattice. In the latter case, such a metal ion would likewise bind the at least one at least bidentate organic compound or a further at least bidentate organic compound.

Here, it is in principle possible to use any metal ion which is suitable as part of the porous metal organic framework. Mixtures of the metals titanium, zirconium and hafnium can likewise be present as metal ions. If more than one metal ion are comprised in the porous metal organic framework, these can be present in stoichiometric or nonstoichiometric amounts. If coordination sites are occupied by a further metal ion and this is present in a nonstoichiometric ratio to one of the abovementioned metal ions, such a porous metal organic framework can be regarded as a doped framework. The preparation of such doped metal organic frameworks in general is described in the German patent application No. 10 2005 053430.9. For the purposes of the present invention, a preparation according to the invention can be carried out by means of this preparative method as long as the metal compounds used are inorganic salts.

In addition, the porous metal organic framework can be impregnated with a further metal in the form of a metal salt. A method of impregnation is described, for example, in EP-A 1070538.

If a further metal ion is present in a stoichiometric ratio to the first metal ion selected from the group consisting of titanium, zirconium and hafnium, mixed metal frameworks are obtained. Here, the further metal ion can participate in formation of the framework or not participate in this.

The framework is preferably made up only of metal ions selected from the group consisting of titanium, zirconium and hafnium and the at least one at least bidentate organic compound. Furthermore, the framework is preferably formed exclusively by one of the metals titanium, zirconium or hafnium.

The framework can be present in polymeric form or as polyhedron.

If more than one metal ion is present in the framework, the process of the invention is accordingly carried out using more than one metal compound, with each of the metal compounds being an inorganic salt.

For the purposes of the present invention, the metals titanium, zirconium and hafnium are preferably present in the oxidation state +4.

In addition, the porous metal organic framework comprises at least one bidentate organic compound which is derived from a dicarboxylic, tricarboxylic or tetracarboxylic acid. It is possible for further at least bidentate organic compounds to participate in formation of the framework. However, it is likewise possible for organic compounds which are not at least bidentate also to be comprised in the framework. These can, for example, be derived from a monocarboxylic acid.

For the purposes of the present invention, the term “derived” means that the dicarboxylic, tricarboxylic or tetracarboxylic acid can be present in partly deprotonated or completely deprotonated form in the framework. Furthermore, the dicarboxylic, tricarboxylic or tetracarboxylic acid can comprise a substituent or a plurality of independent substituents. Examples of such substituents are —OH, —NH₂, —OCH₃, —CH₃, —NH(CH₃), —N(CH₃)₂, —CN and halides. In addition, for the purposes of the present invention, the term “derived” means that the dicarboxylic, tricarboxylic or tetracarboxylic acid can also be present in the form of a corresponding sulfur analogue. Sulfur analogues are the functional groups —C(═O)SH and its tautomers and C(═S)SH, which can be used in place of one or more carboxylic acid groups. In addition, for the purposes of the present invention, the term “derived” means that one or more carboxylic acid functions can be replaced by a sulfonic acid group (—SO₃H). In addition, a sulfonic acid group can likewise be present in addition to the 2, 3 or 4 carboxylic acid functions.

The dicarboxylic, tricarboxylic or tetracarboxylic acid has, in addition to the abovementioned functional groups, an organic skeleton or an organic compound to which these are bound. Here, the abovementioned functional groups can in principle be bound to any suitable organic compound as long as it is ensured that the organic compound bearing these functional groups is capable of forming the coordinate bond to produce the framework.

The organic compounds are preferably derived from a saturated or unsaturated aliphatic compound or an aromatic compound or a both aliphatic and aromatic compound.

The aliphatic compound or the aliphatic part of the both aliphatic and aromatic compound can be linear and/or branched and/or cyclic, with a plurality of rings per compound also being possible. The aliphatic compound or the aliphatic part of the both aliphatic and aromatic compound more preferably comprises from 1 to 18, more preferably from 1 to 14, more preferably from 1 to 13, more preferably from 1 to 12, more preferably from 1 to 11 and particularly preferably from 1 to 10, carbon atoms, for example 1, 2, 3, 4, 5, 6, 7, 8, 9 or 10 carbon atoms. Particular preference is here given to, inter alia, methane, adamantane, acetylene, ethylene or butadiene.

The aromatic compound or the aromatic part of the both aromatic and aliphatic compound can have one or more rings, for example two, three, four or five rings, with the rings being able to be present separately from one another and/or at least two rings can be present in fused form. The aromatic compound or the aromatic part of the both aliphatic and aromatic compound particularly preferably has one, two or three rings, with particular preference being given to one or two rings. Furthermore, the rings of said compound can each comprise, independently of one another, at least one heteroatom such as N, O, S, B, P, Si, preferably N, O and/or S. More preferably, the aromatic compound or the aromatic part of the both aromatic and aliphatic compound comprises one or two C₆ rings; in the case of two rings, they can be present either separately from one another or in fused form. Aromatic compounds of which particular mention may be made are benzene, naphthalene and/or biphenyl and/or bipyridyl and/or pyridyl.

The at least bidentate organic compound is more preferably an aliphatic or aromatic, acyclic or cyclic hydrocarbon which has from 1 to 18, preferably from 1 to 10 and in particular 6, carbon atoms and additionally bears exclusively 2, 3 or 4 carboxyl groups as functional groups.

For example, the at least bidentate organic compound is derived from a dicarboxylic acid such as oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, peryiene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octadicarboxylic acid, pentane-3,3-dicarboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyraxole-3,4-dicarboxylic acid, 2,3-pyrazinedicarboxylic acid, 5,6-dimethyl-2,3-pyrazinedicarboxylic acid, (bis(4-aminophenyl) ether)diimidedicarboxylic acid, 4,4′-diaminodiphenylmethanediimidedicarboxylic acid, (bis(4-aminophenyl)sulfone)diimidedicarboxylic acid, 1,4-naphthalenedicarboxylic acid, 2,6-naphthalenedicarboxylic acid, 1,3-adamantanedicarboxylic acid, 1,8-naphthalene-dicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexane-1,2-dicarboxylic acid, hexatriacontanedicarboxylic acid, tetradecanedicarboxylic acid, 1,7-heptadicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid or camphordicarboxylic acid.

Furthermore, the at least bidentate organic compound is more preferably one of the dicarboxylic acids mentioned above by way of example itself.

For example, the at least bidentate organic compound can be derived from a tricarboxylic acid such as 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid.

Furthermore, the at least bidentate organic compound is more preferably one of the tricarboxylic acids mentioned above by way of example itself.

Examples of an at least bidentate organic compound derived from a tetracarboxylic acid are

1,1-dioxidoperylo[1,12-BCD]thiophene-3,4,9,10-tetracarboxylic acid, perylene-tetracarboxylic acids such as perylene-3,4,9,10-tetracarboxylic acid or (perylene 1,12-sulfone)-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,1,1,2-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

Furthermore, the at least bidentate organic compound is more preferably one of the tetracarboxylic acids mentioned above by way of example itself.

Very particular preference is given to using optionally at least monosubstituted aromatic dicarboxylic, tricarboxylic or tetracarboxylic acids which have one, two, three, four or more rings and in which each of the rings can comprise at least one heteroatom, with two or more rings being able to comprise identical or different heteroatoms. For example, preference is given to one-ring dicarboxylic acids, one-ring tricarboxylic acids, one-ring tetracarboxylic acids, two-ring dicarboxylic acids, two-ring tricarboxylic acids, two-ring tetracarboxylic acids, three-ring dicarboxylic acids, three-ring tricarboxylic acids, three-ring tetracarboxylic acids, four-ring dicarboxylic acids, four-ring tricarboxylic acids and/or four-ring tetracarboxylic acids. Suitable heteroatoms are, for example, N, O, S, B, P, and preferred heteroatoms here are N, S and/or O, Suitable substituents which may be mentioned in this respect are, inter alia, —OH, a nitro group, an amino group or an alkyl or alkoxy group.

Particular preference is given to using acetylenedicarboxylic acid (ADC), camphordicarboxylic acid, fumaric acid, succinic acid, benzenedicarboxylic acids, naphthalenedicarboxylic acids, biphenyldicarboxylic acids such as 4,4′-biphenyldicarboxylic acid (BPDC), pyrazinedicarboxylic acids such as 2,5-pyrazinedicarboxylic acid, bipyridinedicarboxylic acids such as 2,2′-bipyridinedicarboxylic acids such as 2,2′-bipyridine-5,5′-dicarboxylic acid, benzenetricarboxylic acids such as 1,2,3-, 1,2,4-benzenetricarboxylic acid or 1,3,5-benzenetricarboxylic acid (BTC), benzenetetracarboxylic acid, adamantanetetracarboxylic acid (ATC), adamantanedibenzoate (ADB), benzenetribenzoate (BTB), methanetetrabenzoate (MTB), adamantanetetrabenzoate or dihydroxyterephthalic acids such as 2,5-dihydroxyterephthalic acid (DHBDC) as at least bidentate organic compounds.

Very particular preference is given to, inter alia, phthalic acid, isophthalic acid, terephthalic acid, 2,6-naphthalenedicarboxylic acid, 1,4-naphthalenedicarboxylic acid, 1,5-naphthalenedicarboxylic acid, 1,2,3-benzenetricarboxylic acid, 1,2,4-benzenetricarboxylic acid, 1,3,5-benzenetricarboxylic acid or 1,2,4,5-benzenetetracarboxylic acid.

Apart from these at least bidentate organic compounds, the metal organic framework can further comprise one or more monodentate ligands and/or one or more bidentate ligands which are not derived from a dicarboxylic, tricarboxylic or tetracarboxylic acid.

The at least one at least bidentate organic compound preferably does not comprise any hydroxy or phosphonic acid groups.

As indicated above, one or more carboxylic acid functions can be replaced by a sulfonic acid function. Furthermore, a sulfonic acid group can additionally be present. Finally, it is likewise possible for all carboxylic acid functions to be replaced by a sulfonic acid function.

Such sulfonic acids or salts thereof which are commercially available are, for example, 4-amino-5-hydroxynaphthalene-2,7-disulfonic acid, 1-amino-8-naphthol-3,6-disulfonic acid, 2-hydroxynaphthalene-3,6-disulfonic acid, benzene-1,3-disulfonic acid, 1,8-dihydroxynaphthalene-3,6-disulfonic acid, 1,2-dihydroxybenzene-3,5-disulfonic acid, 4,5-dihydroxynaphthalene-2,7-disulfonic acid, 2,9-dimethyl-4,7-diphenyl-1,10-phenanthrolinedisulfonic acid, 4,7-diphenyl-1,10-phenanthrolinedisulfonic acid, ethane-1,2-disulfonic acid, naphthalene-1,5-disulfonic acid, 2-(4-nitrophenylazo)-1,8-dihydroxynaphthalene-3,6-disulfonic acid, 2,2′-dihydroxy-1,1′-azonaphthalene-3′,4,6′-trisulfonic acid.

The metal organic frameworks according to the present invention comprise pores, in particular micropores and/or mesopores. Micropores are defined as pores having a diameter of 2 nm or less and mesopores are defined by a diameter in the range from 2 to 50 nm, in each case in accordance with the definition given in Pure Applied Chem. 57 (1985), pages 603-619, in particular on page 606. The presence of micropores and/or mesopores can be checked by means of sorption measurements, with these measurements determining the uptake capacity of the metal organic frameworks for nitrogen at 77 kelvin in accordance with DIN 66131 and/or DIN 66134.

The specific surface area, calculated according to the Langmuir model (DIN 66131, 66134), of an MOF in powder form is preferably more than 5 m²/g, more preferably above 10 m²/g, more preferably more than 50 m²/g, even more preferably more than 500 m²/g, even more preferably more than 1000 m²/g.

Shaped bodies of metal organic frameworks can have a lower specific surface area, but preferably more than 10 m²/g, more preferably more than 50 m²/g, even more preferably more than 500 m²/g.

The pore size of the porous metal organic framework can be controlled by selection of the appropriate ligand and/or the at least bidentate organic compound. In general, the larger the organic compound, the larger the pore size. The pore size is preferably from 0.2 nm to 30 nm, particularly preferably in the range from 0.3 nm to 3 nm, based on the crystalline material.

However, larger pores whose size distribution can vary also occur in a shaped MOF body. However, preference is given to more than 50% of the total pore volume, in particular more than 75%, being made up by pores having a pore diameter of up to 1000 nm. However, a large part of the pore volume is preferably made up by pores having two different diameter ranges. It is therefore more preferred for more than 25% of the total pore volume, in particular more than 50% of the total pore volume, to be made up by pores which are in a diameter range from 100 nm to 800 nm and for more than 15% of the total pore volume, in particular more than 25% of the total pore volume, to be made up by pores which are in a diameter range up to 10 nm. The pore distribution can be determined by means of mercury porosimetry.

The metal organic framework can be present in powder form or as agglomerates. The framework can be used as such or is converted into a shaped body. Accordingly, a further aspect of the present invention is a shaped body comprising the metal organic framework according to the invention.

The production of shaped bodies from metal organic frameworks is described, for example, in WO-A 03/102000.

Preferred processes for producing shaped bodies here are extrusion or tableting. In the production of the shaped bodies, the framework can be mixed with further materials such as binders, lubricants or other additives which are added during production. It is likewise conceivable for the framework to be mixed with further constituents, for example absorbents such as activated carbon or the like.

The possible geometries of the shaped bodies are in principle not subject to any restrictions. For example, possible shapes are, inter alia, pellets such as disk-shaped pellets, pills, spheres, granules, extrudates such as rods, honeycombs, grids or hollow bodies.

To produce these shaped bodies, it is in principle possible to employ all suitable methods. In particular, the following processes are preferred:
Kneading/pan milling of the framework either alone or together with at least one binder and/or at least one pasting agent and/or at least one template compound to give a mixture; shaping of the resulting mixture by means of at least one suitable method such as extrusion; optionally washing and/or drying and/or calcination of the extrudate; optionally finishing treatment.
Tableting together with at least one binder and/or another auxiliary.
Application of the framework to at least one optionally porous support material. The material obtained can then be processed further by the above-described method to give a shaped body.
Application of the framework to at least one optionally porous substrate.

Kneading/pan milling and shaping can be carried out by any suitable method, for example as described in Ullmanns Enzyklopadie der Technischen Chemie, 4th edition, volume 2, p. 313 ff. (1972).

For example, the kneading/pan milling and/or shaping can be carried out by means of a piston press, roller press in the presence or absence of at least one binder, compounding, pelletization, tableting, extrusion, coextrusion, foaming, spinning, coating, granulation, preferably spray granulation, spraying, spray drying or a combination of two or more of these methods.

Very particular preference is given to producing pellets and/or tablets.

The kneading and/or shaping can be carried out at elevated temperatures, for example in the range from room temperature to 300° C., and/or under superatmospheric pressure, for example in the range from atmospheric pressure to a few hundred bar, and/or in a protective gas atmosphere, for example in the presence of at least one noble gas, nitrogen or a mixture of two or more thereof.

The kneading and/or shaping is, in a further embodiment, carried out with addition of at least one binder, with the binder used basically being able to be any chemical compound which ensures the desired viscosity for the kneading and/or shaping of the composition to be kneaded and/or shaped. Accordingly, binders can, for the purposes of the present invention, be either viscosity-increasing or viscosity-reducing compounds.

Preferred binders are, for example, inter alia aluminum oxide or binders comprising aluminum oxide, as are described, for example, in WO 94/29408, silicon dioxide as described, for example, in EP 0 592 050 A1, mixtures of silicon dioxide and aluminum oxide, as are described, for example, in WO 94/13584, clay minerals as described, for example, in JP 03-037156 A, for example montmorillonite, kaolin, bentonite, hallosite, dickite, nacrite and anauxite, alkoxysilanes as described, for example, in EP 0 102 544 B1, for example tetraalkoxysilanes such as tetramethoxysilane, tetraethoxysilane, tetrapropoxysilane, tetrabutoxysilane, or, for example, trialkoxysilanes such as trimethoxysilane, triethoxysilane, tripropoxysilane, tributoxysilane, alkoxytitanates, for example tetraalkoxytitanates such as tetramethoxytitanate, tetraethoxytitanate, tetrapropoxytitanate, tetrabutoxytitanate, or, for example, trialkoxytitanates such as trimethoxytitanate, triethoxytitanate, tripropoxytitanate, tributoxytitanate, alkoxyzirconates, for example tetraalkoxyzirconates such as tetramethoxyzirconate, tetraethoxyzirconate, tetrapropoxyzirconate, tetrabutoxyzirconate, or, for example, trialkoxyzirconates such as trimethoxyzirconate, triethoxyzirconate, tripropoxyzirconate, tributoxyzirconate, silica sols, amphiphilic substances, and/or graphites.

As viscosity-increasing compound, it is, for example, also possible to use, if appropriate in addition to the abovementioned compounds, an organic compound and/or a hydrophilic polymer such as cellulose or a cellulose derivative such as methylcellulose and/or a polyacrylate and/or a polymethacrylate and/or a polyvinyl alcohol and/or a polyvinylpyrrolidone and/or a polyisobutene and/or a polytetrahydrofuran and/or a polyethylene oxide.

As pasting agent, it is possible to use, inter alia, preferably water or at least one alcohol such as a monoalcohol having from 1 to 4 carbon atoms, for example methanol, ethanol, n-propanol, isopropanol, 1-butanol, 2-butanol, 2-methyl-1-propanol or 2-methyl-2-propanol or a mixture of water and at least one of the alcohols mentioned or a polyhydric alcohol such as a glycol, preferably a water-miscible polyhydric alcohol, either alone or as a mixture with water and/or at least one of the monohydric alcohols mentioned.

Further additives which can be used for kneading and/or shaping are, inter alia, amines or amine derivatives such as tetraalkylammonium compounds or amino alcohols and carbonate-comprising compounds such as calcium carbonate. Such further additives are described, for instance, in EP 0 389 041 A1, EP 0 200 260 A1 or WO 95/19222.

The order of the additives such as template compound, binder, pasting agent, viscosity-increasing substance during shaping and kneading is in principle not critical.

In a further, preferred embodiment, the shaped body obtained by kneading and/or shaping is subjected to at least one drying step which is generally carried out at a temperature in the range from 25 to 500° C., preferably in the range from 50 to 500° C. and particularly preferably in the range from 100 to 350° C. It is likewise possible to carry out drying under reduced pressure or under a protective gas atmosphere or by spray drying.

In a particularly preferred embodiment, at least one of the compounds added as additives is at least partly removed from the shaped body during this drying process.

The at least one metal compound is preferably a halide, sulfide, the salt of an inorganic oxygen-comprising acid, if appropriate in the form of a hydrate, or a mixture thereof.

A halide is, for example, chloride, bromide or iodide.

An inorganic oxygen-comprising acid is, for example, sulfuric acid, sulfurous acid, phosphoric acid or nitric acid.

Here, the metal ion of the metal compound preferably occurs as Me⁴⁺ or MeO²⁺ cation.

More preferred metal compounds in the case of zirconium are zirconium chloride, zirconium oxychloride, zirconium sulfate, zirconium phosphate, zirconium oxynitrate, zirconium hydrogensulfate. If these compounds occur as hydrates, it is also possible to use these.

More preferred metal compounds in the case of titanium are titanium chloride, titanium nitrate, titanium oxosulfate, titanium sulfate and titanium sulfides. If these compounds occur as hydrates, it is also possible to use these.

The reaction in the process of the invention is preferably carried out in the presence of a nonaqueous solvent.

The reaction is preferably carried out at a pressure of not more than 2 bar (absolute). However, the pressure is preferably not more than 1230 mbar (absolute). The reaction particularly preferably takes place at atmospheric pressure. However, the pressures here can be slightly above or below atmospheric pressure due to the apparatus. For the purposes of the present invention, the term “atmospheric pressure” therefore refers to the pressure range comprising the actual atmospheric pressure ±150 mbar.

The reaction can be carried out at room temperature. However, it preferably takes place at temperatures above room temperature. The temperature is preferably more than 100° C. The temperature is also preferably not more than 180° C. and more preferably not more than 150° C.

The above-described metal organic frameworks are typically prepared in water as solvent with addition of a further base. This serves, in particular, to make a polybasic carboxylic acid used as at least bidentate organic compound readily soluble in water. The preferred use of the nonaqueous organic solvent makes it unnecessary to use such a base. Nevertheless, the solvent for the process of the invention can be selected so that it has a basic reaction, but this is not absolutely necessary for carrying out the process of the invention.

It is likewise possible to use a base, but preference is given to using no additional base.

It is also advantageous for the reaction to take place with stirring, which is advantageous in the case of a scale-up, too.

The nonaqueous organic solvent is preferably a C₁₋₆alkanol, dimethyl sulfoxide (DMSO), N,N-dimethylformamide (DMF), N,N-diethylformamide (DEF), acetonitrile, toluene, dioxane, benzene, chlorobenzene, methyl ethyl ketone (MEK), pyridine, tetrahydrofuran (THF), ethyl acetate, optionally halogenated C₁₋₂₀₀-alkane, sulfolane, glycol, N-methylpyrrolidone (NMP), gamma-butyrolactone, alicyclic alcohols such as cyclohexanol, ketones such as acetone or acetylacetone, cyclic ketones such as cyclohexanone, sulfolene or mixtures thereof.

A C₁₋₆alkanol is an alcohol having from 1 to 6 carbon atoms. Examples are methanol, ethanol, n-propanol, i-propanol, n-butanol, i-butanol, t-butanol, pentanol, hexanol and mixtures thereof.

An optionally halogenated C₁₋₂₀₀-alkane is an alkane which has from 1 to 200 carbon atoms and in which one or more to all hydrogen atoms can be replaced by halogen, preferably chlorine or fluorine, in particular chlorine. Examples are chloroform, dichloromethane, tetrachloromethane, dichloroethane, hexane, heptane, octane and mixtures thereof.

Preferred solvents are DMF, DEF and NMP. Particular preference is given to DMF.

The term “nonaqueous” preferably refers to a solvent which does not exceed a maximum water content of 10% by weight, more preferably 5% by weight, even more preferably 1% by weight, very preferably 0.1% by weight, particularly preferably 0.01% by weight, based on the total weight of the solvent.

The maximum water content during the reaction is preferably 10% by weight, more preferably 5% by weight and even more preferably 1% by weight.

The term “solvent” refers both to pure solvents and to mixtures of various solvents.

The process step of reaction of the at least one metal compound with the at least one at least bidentate organic compound is more preferably followed by a calcination step. The temperature set here is typically more than 250° C., preferably from 300 to 400° C.

As a result of the calcination step, the at least bidentate organic compound present in the pores can be removed.

In addition or as an alternative thereto, the removal of the at least bidentate organic compound (ligand) from the pores of the porous metal organic framework can be effected by treatment of the framework material formed with a nonaqueous solvent. Here, the ligand is removed and, if appropriate, replaced in the framework by a solvent molecule in a type of “extraction process”. This mild method is particularly useful when the ligand is a high-boiling compound.

The treatment preferably takes at least 30 minutes and can typically be carried out for up to 2 days. This can occur at room temperature or elevated temperature. It preferably occurs at elevated temperature, for example at least 40° C., preferably 60° C. The extraction more preferably takes place at the boiling point of the solvent used (under reflux).

The treatment can be carried out in a simple vessel by slurrying and stirring the framework. It is also possible to use extraction apparatuses such as Soxhlet apparatuses, in particular industrial extraction apparatuses.

As suitable solvents, it is possible to use those mentioned above, i.e., for example, C₁₋₆ alkanol, dimethyl sulfoxide (DMSO), N,N-dimethylformamide (DMF), N,N-diethylformamide (DEF), acetonitrile, toluene, dioxane, benzene, chlorobenzene, methyl ethyl ketone (MEK), pyridine, tetrahydrofuran (THF), ethyl acetate, optionally halogenated C₁₋₂₀₀-alkane, sulfolane, glycol, N-methylpyrrolidone (NMP), gamma-butyrolactone, alicyclic alcohols such as cyclohexanol, ketones such as acetone or acetylacetone, cyclic ketones such as cyclohexanone or mixtures thereof.

Preference is given to methanol, ethanol, propanol, acetone, MEK and mixtures thereof.

A very particularly preferred extractant is methanol.

The solvent used for the extraction can be the same as or different from that for the reaction of the at least one metal compound with the at least one at least bidentate organic compound. In particular, it is not absolutely necessary but preferred for the solvent in the “extraction” to be water-free.

The porous metal organic framework prepared according to the invention can be used, for example, for the uptake of at least one substance for the purposes of its storage, separation, controlled release or chemical reaction and also as support material or precursor material for producing a corresponding metal oxide.

If the porous metal organic framework is used for storage, this preferably occurs in a temperature range from −200° C. to +80° C. Greater preference is given to a temperature range from −40° C. to +80° C.

The at least one substance can be a gas or a liquid. The substance is preferably a gas.

For the purposes of the present invention, the terms “gas” and “liquid” are used in the interests of simplicity, but gas mixtures and liquid mixtures or liquid solutions are likewise encompassed by the term “gas” or “liquid”.

Preferred gases are hydrogen, natural gas, town gas, saturated hydrocarbons, in particular methane, ethane, propane, n-butane and i-butane, unsaturated hydrocarbons, in particular ethene or propene, carbon monoxide, carbon dioxide, nitrogen oxides, oxygen, sulfur oxides, halogens, halogenated hydrocarbons, NF₃, SF₆, ammonia, boranes, phosphanes, hydrogen sulfide, amines, formaldehyde, noble gases, in particular helium, neon, argon, krypton and xenon.

The at least one substance can, however, also be a liquid. Examples of such a liquid are disinfectants, inorganic or organic solvents, fuels, in particular gasoline or diesel, hydraulic fluid, radiator fluid, brake fluid or an oil, in particular machine oil. The liquid can also be halogenated aliphatic or aromatic, cyclic or acyclic hydrocarbons or a mixture thereof. In particular, the liquid can be acetone, acetonitrile, aniline, anisole, benzene, benzonitrile, bromobenzene, butanol, tert-butanol, quinoline, chlorobenzene, chloroform, cyclohexane, diethylene glycol, diethyl ether, dimethylacetamide, dimethylformamide, dimethyl sulfoxide, dioxane, glacial acetic acid, acetic anhydride, ethyl acetate, ethanol, ethylene carbonate, ethylene dichloride, ethylene glycol, ethylene glycol dimethyl ether, formamide, hexane, isopropanol, methanol, methoxypropanol, 3-methyl-1-butanol, methylene chloride, methyl ethyl ketone, N-methylformamide, N-methylpyrrolidone, nitrobenzene, nitromethane, piperidine, propanot, propylene carbonate, pyridine, carbon disulfide, sulfolane, tetrachloroethene, carbon tetrachloride, tetrahydrofuran, toluene, 1,1,1-trichloroethane, trichloroethylene, triethylamine, triethylene glycol, triglyme, water or a mixture thereof.

Furthermore, the at least one substance can be an odorous substance.

The odorous substance is preferably a volatile organic or inorganic compound which comprises at least one of the elements nitrogen, phosphorus, oxygen, sulfur, fluorine, chlorine, bromine or iodine or is an unsaturated or aromatic hydrocarbon or a saturated or unsaturated aldehyde or a ketone. More preferred elements are nitrogen, oxygen, phosphorus, sulfur, chlorine, bromine; and particular preference is given to nitrogen, oxygen, phosphorus and sulfur.

In particular, the odorous substance is ammonia, hydrogen sulfide, sulfur oxides, nitrogen oxides, ozone, cyclic or acyclic amines, thiols, thioethers and aldehydes, ketones, esters, ethers, acids or alcohols. Particular preference is given to ammonia, hydrogen sulfide, organic acids (preferably acetic acid, propionic acid, butyric acid, isobutyric acid, valeric acid, isovaleric acid, caproic acid, heptanoic acid, lauric acid, pelargonic acid) and also cyclic or acyclic hydrocarbons which comprise nitrogen or sulfur and also saturated or unsaturated aldehydes such as hexanal, heptanal, octanal, nonanal, decanal, octenal or nonenal and in particular volatile aldehydes such as buyraldehyde, propionaldehyde, acetaldehyde and formaldehyde and also fuels such as gasoline, diesel (constituents).

The odorous substances can also be fragrances which are used, for example, for producing perfumes. Examples of fragrances or oils which can release such fragrances are: essential oils, basil oil, geranium oil, mint oil, cananga oil, cardamom oil, lavender oil, peppermint oil, nutmeg oil, chamomile oil, eucalyptus oil, rosemary oil, lemon oil, lime oil, orange oil, bergamot oil, muscatel sage oil, coriander oil, cypress oil, 1,1-dimethoxy-2-phenylethane, 2,4-dimethyl-4-phenyltetrahydrofuran, dimethyltetrahydrobenzaldehyde, 2,6-dimethyl-7-octen-2-ol, 1,2-diethoxy-3,7-dimethyl-2,6-octadiene, phenylacetaldehyde, rose oxide, ethyl-2-methylpentanoate, 1-(2,6,6-trimethyl-1,3-cyclohexadien-1-yl)-2-buten-1-one, ethyl vanillin, 2,6-dimethyl-2-octenol, 3,7-dimethyl-2-octenol, tert-butylcyclohexyl acetate, anisyl acetate, allyl cyclohexyloxyacetate, ethyllinalool, eugenol, coumarin, ethyl acetoacetate, 4-phenyl-2,4,6-trimethyl-1,3-dioxane, 4-methylene-3,5,6,6-tetramethyl-2-heptanone, ethyl tetrahydrosafranate, geranyl nitrile, cis-3-hexen-1-ol, cis-3-hexenyl acetate, cis-3-hexenyl methylcarbonate, 2,6-dimethyl-5-hepten-1-al, 4-(tricyclo[5.2.1.0]decylidene)-8-butanal, 5-(2,2,3-trimethyl-3-cyclopentdnyl)-3-methylpentan-2-ol, p-tert-butyl-alpha-methylhydrocinnamaldehyde, ethyl[5.2.1.0]tricyclodecanecarboxylate, geraniol, citronellol, citral, linalool, linalyl acetate, ionone, phenylethanol and mixtures thereof.

For the purposes of the present invention, a volatile odorous substance preferably has a boiling point or boiling point range below 300° C. The odorous substance is more preferably a readily volatile compound or mixture. The odorous substance particularly preferably has a boiling point or boiling range below 250° C., more preferably below 230° C., particularly preferably below 200° C.

Preference is likewise given to odorous substances which have a high volatility. The vapor pressure can be employed as a measure of the volatility. For the purposes of the present invention, a volatile odorous substance preferably has a vapor pressure of more than 0.001 kPa (20° C.). The odorous substance is more preferably a readily volatile compound or mixture. The odorous substance particularly preferably has a vapor pressure of more than 0.01 kPa (20° C.), more preferably a vapor pressure of more than 0.05 kPa (20° C.). The odorous substances particularly preferably have a vapor pressure of more than 0.1 kPa (20° C.).

In addition, it has been found to be advantageous that the porous metal organic frameworks prepared according to the invention can be used for preparing corresponding metal oxides. Possible oxides here are accordingly the metal oxides of titanium, zirconium and hafnium and also mixed oxides of these with one another or with other metals.

### EXAMPLES

### Example 1

### Preparation of a Zr-MOF

5 g of ZrOCl₂ and 9.33 g of terephthalic acid are stirred in 300 ml of DMF at 130° C. under reflux in a glass flask for 17 hours. The precipitate is filtered off, washed with 3×50 ml of DMF and 4×50 ml of methanol and predried at 150° C. in a vacuum drying oven for 4 days. Finally, the material is calcined at 275° C. (100 l/h of air) in a muffle furnace for 2 days. This gives 5.17 g of a brown material.

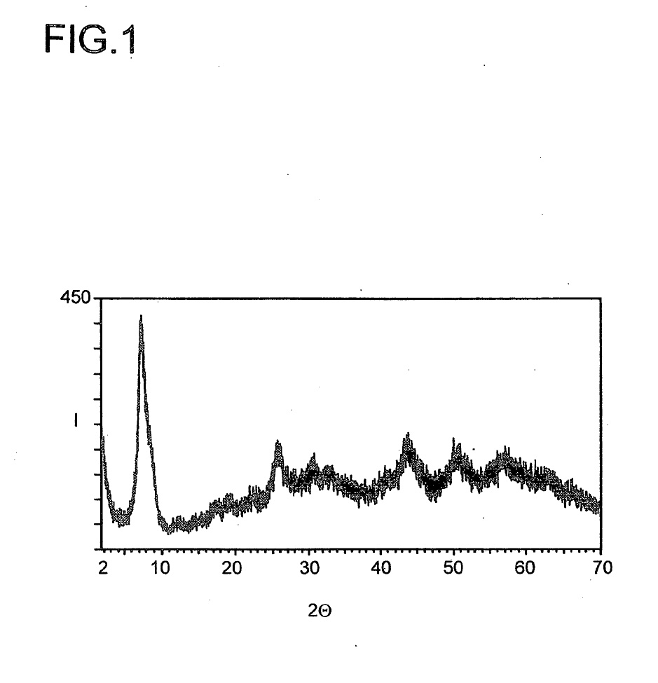

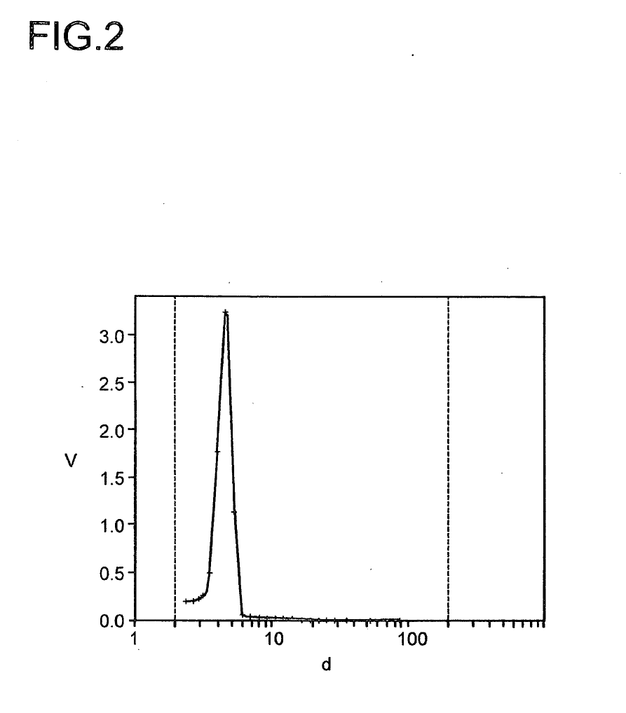

According to elemental analysis, the material comprises 26.4% by weight of Zr, 32.8% by weight of C, 37.5% by weight of 0, 2.7% by weight of H and traces of Cl and N. This composition indicates the formation of an organic Zr compound. FIG. 1 shows the associated X-ray diffraction pattern (XRD), with I indicating the intensity (Lin(counts)) and 2Θ describing the 2-theta scale. The pore structure is shown in FIG. 2. Here, the pore volume V (ccm/g) is shown as a function of the pore diameter d (nm). The surface area is determined by means of N₂ sorption and found to be 836 m²/g (Langmuir model). The pore volume is 0.5 ml/g. Both the XRD and the pore structure indicate the actual formation of a porous MOF structure.

### Example 2

### Preparation of a Zr-MOF

5 g of ZrO(NO₃)*₂H₂O and 6.67 g of terephthalic acid are stirred in 300 ml of DMF at 130° C. under reflux in a glass flask for 17 hours. The precipitate is filtered off, washed with 3×50 ml of DMF and 4×50 ml of methanol and predried at 150° C. in a vacuum drying oven for 4 days. Finally, the material is calcined at 275° C. (100 l/h of air) in a muffle furnace for 2 days. This gives 4.73 g of a brown material.

According to elemental analysis, the material comprises 26.0% by weight of Zr, 34.1% by weight of C, 36.7% by weight of 0, 2.6% by weight of H and small amounts of N (traces of. solvent). The surface area is determined by means of N₂ sorption and found to be 546 m²/g (Langmuir model).

### Example 3

### Preparation of a Ti-MOF

7 g of TiOSO₄*H₂O and 14.54 g of terephthalic acid are stirred in 300 ml of DMF at 130° C. under reflux in a glass flask for 18 hours. The precipitate is filtered off, washed with 3×50 ml of DMF and 4×50 ml of methanol and predried at 110° C. in a vacuum drying oven for 20 hours. 4.48 g of the total of 7.5 g are additionally calcined at 200° C. (200 l/h of air) in a muffle furnace for 2 days. This gives 4.05 g of a light-brown material.

According to elemental analysis, the material comprises 19.8% by weight of Ti, 13.7% by weight of C, 3.4% by weight of H, 13.9% by weight of 5 and 5.1% by weight of N. The balance is oxygen.

### Example 4

### Preparation of a Ti-MOF

10 g of TiCl₄ and 8.76 g of terephthalic acid are stirred in 300 ml of DMF at 130° C. under reflux in a glass flask for 19 hours. The precipitate is filtered off, washed with 3×50 ml of DMF and 4×50 ml of methanol and dried at 110° C. in a vacuum drying oven for 16 hours. This gives 3.12 g of a yellowish material.

### Example 5

### Hydrogen Uptake of a Framework as Per Example 1

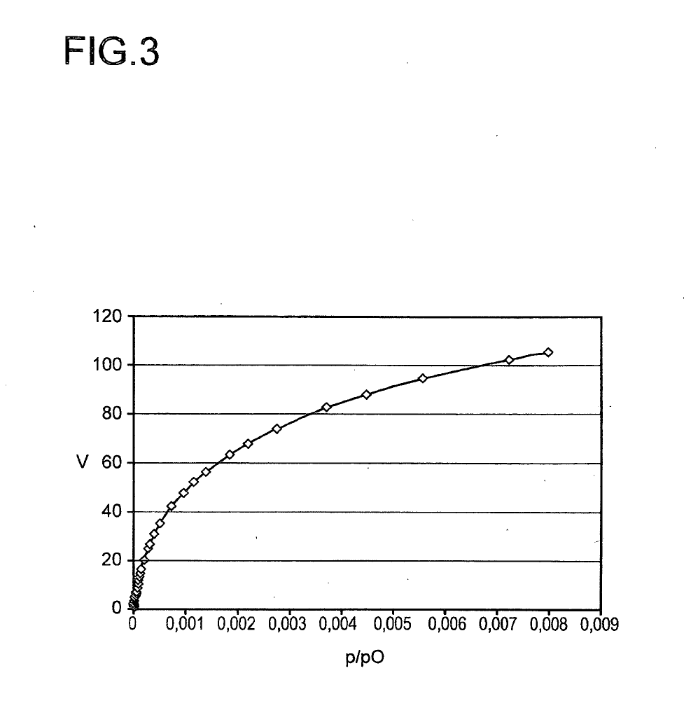

The measurement is carried out in a commercially available instrument from Quantachrome having the designation Autosorb-1. The measurement temperature was 77.4 K. Prior to the measurement, the samples were in each case pretreated at room temperature for 4 hours and subsequently at 200° C. under reduced pressure for a further 4 hours. The curve obtained is shown in FIG. 3. Here, the H₂ uptake is shown in m²/g of MOF (V) as a function of the pressure p/p₀.

### Example 6

### Preparation of Zirconium Oxide

The zirconium-terephthalic acid MOF from Example 1 is calcined at 500° C. for 48 hours.

The product is a zirconium oxide having an N₂ surface area of 61 m²/g (Langmuir).

1-10. (canceled)

11. A process for preparing a porous metal organic framework comprising at least one at least bidentate organic compound coordinated to at least one metal ion, which comprises:
reaction of at least one metal compound with at least one at least bidentate organic compound which can coordinate to the metal, with the metal ion of the at least one metal compound being selected from the group of metals consisting of titanium, zirconium and hafnium and the at least one at least bidentate organic compound being derived from a dicarboxylic, tricarboxylic or tetracarboxylic acid,
wherein the metal compound is an inorganic salt.

12. The process according to claim 11, wherein the metal is zirconium.

13. The process according to claim 11, wherein the at least bidentate organic compound is phthalic acid, isophthalic acid, terephthalic acid, 2,6-naphthalenedicarboxylic acid, 1,4-naphthalenedicarboxylic acid, 1,5-naphthalenedicarboxylic acid, 1,2,3-benzenetricarboxylic acid, 1,2,4-benzenetricarboxylic acid, 1,3,5-benzenetricarboxylic acid or 1,2,4,5-benzenetricarboxylic acid.

14. The process according to claim 11, wherein the inorganic salt of the at least one metal compound is a halide, sulfide, the salt of an inorganic oxygen-comprising acid, if appropriate in the form of a hydrate, or a mixture thereof.

15. The process according to claim 11, wherein the reaction is carried out in the present of a nonaqueous solvent.

16. The process according to claim 11, wherein the reaction is carried out with stirring.

17. The process according to claim 11, wherein the reaction is carried out at a pressure of not more than 2 bar (absolute).

18. The process according to claim 11, wherein the reaction is carried out without additional base.

19. The process according to claim 11, wherein the nonaqueous solvent is a C₁₋₆-alkanol, DMSO, DMF, DEF, acetonitrile, toluene, dioxane, benezene, chlorobenzene, MEK, pyridine, THF, ethyl acetate, optionally halogenated C₁₋₂₀₀-alkane, sulfolane, glycol, NMP, gamma-butyrolactone, alicyclic alchohols, ketones, cyclic ketones, sulfolene or a mixture thereof.

20. The process according to claim 11, wherein, after the reaction, the framework formed is after-treated with an organic solvent.
